(19) United States
(12) Patent Application Publication
(10) Pub. No.: US 2025/0178627 A1
(43) Pub. Date: Jun. 5, 2025

(54) Method for Operating a Driver Assistance System for Supporting a Driver of a Vehicle in Parking the Vehicle, Computer-Readable Medium, System and Vehicle

(71) Applicant: Bayerische Motoren Werke Aktiengesellschaft, Muenchen (DE)

(72) Inventors: Christian Micus, Unterhaching (DE); Jasper Smeets, Muenchen (DE)

(21) Appl. No.: 18/843,675

(22) PCT Filed: Jan. 31, 2023
(86) PCT No.: PCT/EP2023/052259

§ 371 Date: Sep. 3, 2024

(30) Foreign Application Priority Data
Mar. 29, 2022 (DE) 10 2022 107 440.4

(51) Int. Cl. B60W 50/14; B60W 30/06; G08G 1/14

(52) U.S. Cl. CPC B60W 50/14; B60W 30/06; G08G 1/143; G08G 1/145; B60W 2540/215; B60W 2554/408

(57) ABSTRACT

A method for operating a driver assistance system for supporting a driver of a vehicle in parking the vehicle includes receiving a plurality of parking assistance functions of the vehicle. The method also includes receiving a current navigation target of the vehicle, and determining a first parking type depending on the current navigation target of the vehicle. The method further includes providing a recommendation message for the execution of a parking assistance function from the plurality of parking assistance functions to the driver of the vehicle depending on the first parking type.

The present application is the U.S. national phase of PCT Application PCT/EP2023/052259 filed on Jan. 31, 2023, which claims priority of German patent application No. 10 2022 107 440.4 filed on Mar. 29, 2022, the entire contents of which are incorporated herein by reference.

### TECHNICAL FIELD

The disclosure relates to operating a driver assistance system for supporting a driver of a vehicle in parking the vehicle, and methods and apparatus therefor.

### BACKGROUND

Current vehicles can support a driver in parking in a parking space by means of a plurality of assistance systems. Furthermore, systems are known from the prior art which indicate utilization information relating to parking spaces in multi-story car parks and parking spaces in a navigation system of a vehicle.

There is a need to support a driver of a vehicle more efficiently in parking the vehicle. In particular, there is a need to provide a driver assistance system which supports a driver of the vehicle efficiently in parking the vehicle at a destination.

### SUMMARY

The above-discussed needs, as well as others, are achieved by the features of at least some embodiment disclosed and claimed herein.

A first aspect is distinguished by a method for operating a driver assistance system for supporting a driver of a vehicle in parking the vehicle. The method can be a computer-implemented method and/or a control device-implemented method. The vehicle can be a motor vehicle. The driver assistance system can be operated in combination with a navigation system of the vehicle. For example, the method can be carried out during a destination input and/or a destination prediction of a driving destination and support the driver in parking at the driving destination.

The method comprises receiving a plurality of parking assistance functions of the vehicle. The plurality of parking assistance functions can be vehicle-specific and, for example, depend on a vehicle configuration and/or a current availability of parking assistance functions in the vehicle. The method further comprises receiving a current navigation target of the vehicle. For example, the current navigation target can be entered into a navigation system of the vehicle by a driver or a user of the vehicle and/or predicted by a navigation system of the vehicle.

Furthermore, the method comprises determining a first parking type depending on the current navigation target of the vehicle. A parking type, for example the first parking type, can be determined depending on utilization of parking spaces of one or more parking types at the navigation target. A parking type can be representative of a parking direction and/or a location of a parking space. The location of a parking space can comprise a position or a region of a parking space. Finally, the method comprises providing a recommendation message to the driver of the vehicle for the execution of a parking assistance function from the plurality of parking assistance functions depending on the first parking type.

Advantageously, the method can more flexibly provide parking assistance functions to a driver of the vehicle. The vehicle can provide the driver with a recommendation message relating to a parking assistance function with which the driver has a high probability of finding a parking space in which the vehicle can be parked using the recommended parking assistance function. The driver is thus supported efficiently and proactively in parking the vehicle at a navigation target.

According to an advantageous refinement, the parking type can be representative of a parking direction and/or a location of a parking space. The parking type can be specified precisely thereby. Preferably, a parking assistance function with which the vehicle can be parked partly, highly or fully automatically in a parking space of a parking type is linked with the parking type.

According to a further advantageous refinement, the plurality of parking assistance functions can comprise one or more of the following parking assistance functions:
a parking assistance function for parking in a public multi-story car park; and/or
a parking assistance function for parking in a public parking lot; and/or
a parking assistance function for parking at a private property; and/or
a parking assistance function for parking along a street. In this way, the vehicle can be parked more flexibly in a plurality of parking spaces.

According to a further, advantageous refinement, determining the first parking type depending on the current navigation target of the vehicle can comprise determining utilization of the first parking type, and the method can provide the recommendation message for the execution of a parking assistance function from the plurality of parking assistance functions to a driver of the vehicle depending on the first parking type and the utilization of the first parking type. The utilization can be a forecast utilization at a time of arrival at the navigation target. For example, the utilization can be forecast by using historical utilization data. In this way, the vehicle can more accurately recommend a parking assistance function to the driver. The driver assistance system can be operated more precisely.

According to a further, advantageous refinement, the method can further comprise determining a second parking type depending on the current navigation target of the vehicle, determining a relative frequency of the determined first parking type and a relative frequency of the determined second parking type, and providing a recommendation message for the execution of a parking assistance function from the plurality of parking assistance functions depending on the relative frequency of the first parking type and/or the relative frequency of the second parking type, wherein the parking assistance function from the plurality of parking assistance functions is representative of the determined first parking type and/or the determined second parking type to a driver of the vehicle. In this way, the method can more accurately recommend a parking assistance function to the driver of the vehicle.

According to a further, advantageous refinement, the method can suppress the provision of the recommendation message for the execution of a parking assistance function if the relative frequency of the first parking type and/or the relative frequency of the second parking type lies within a predefined frequency interval. In this way, the method can more accurately recommend a parking assistance function to the driver of the vehicle. For example, if the first parking type and the second parking type are equally: frequent or similarly frequent and therefore lie within the predefined frequency interval, it is possible that a plurality of parking assistance functions of the vehicle lead to similarly poor or good results with respect to a parking space. The recommendation message can therefore be suppressed, in order to prevent with parking one of the parking assistance functions from possibly failing. Only when the relative frequency lies outside the predefined frequency interval can the method recommend a parking assistance function, specifically the more frequent parking assistance function. With the use of the more frequent parking assistance function, the driver can park more successfully.

According to a further, advantageous refinement, the method can further comprise receiving an operating input from the driver to execute the parking assistance function in response to the provided recommendation message, and executing the parking assistance function by the vehicle following the reception of the operating input from the driver to execute the parking assistance function. In this way, the driver can simply execute the recommended parking assistance function.

According to a further, advantageous refinement, the first parking type can be determined depending on a parking behavior of vehicles of a vehicle fleet in an area around the current navigation target, wherein the parking behavior comprises a frequency of a parking space along the street and a frequency of a parking space off the street, and wherein a parking space along the street and a parking space off the street is determined depending on a distance of a parking position of a respective vehicle of the vehicle fleet. In this way, the first parking type can be determined more efficiently.

A further aspect is distinguished by a computer-readable medium for operating a driver assistance system for supporting a driver of a vehicle in parking the vehicle, wherein the computer-readable medium comprises instructions which, when carried out, carry out the above-described method on a computer and/or a control device.

Still a further aspect is distinguished by a system for operating a driver assistance system for supporting a driver of a vehicle in parking the vehicle, wherein the system is designed to carry out the above-described method.

Another aspect is distinguished by a vehicle comprising the above-described system for operating a driver assistance system for supporting a driver of a vehicle in parking the vehicle.

Further features are apparent from the claims, the FIGURE and the FIGURE description. All the features and feature combinations mentioned above in the description and the features and feature combinations mentioned below in the FIGURE description and/or shown on their own in the FIGURE can be used not only in the respectively specified combination but also in other combinations or else on their own.

The above-described features and advantages, as well as others, will become readily apparent to those of ordinary skill in the art by reference to the following detailed description and accompanying drawings.

### BRIEF DESCRIPTION OF THE DRAWING

FIG. 1 shows an exemplary method for operating a driver assistance system for supporting a driver of a vehicle in parking the vehicle.

### DETAILED DESCRIPTION

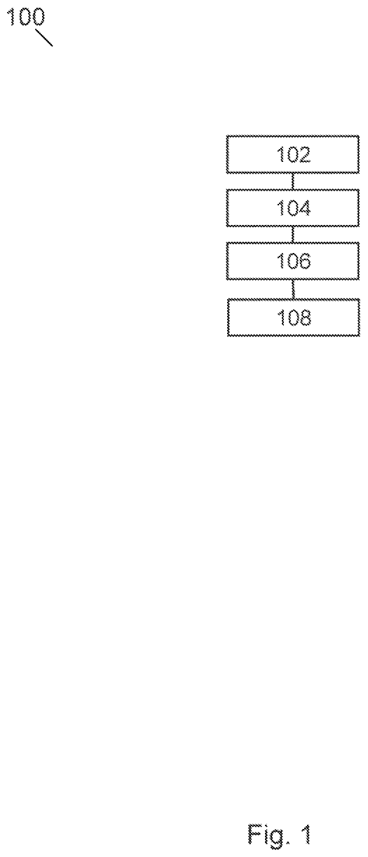

In detail, FIG. 1 shows a method 100 for operating driver assistance system for supporting a driver of a vehicle in parking the vehicle. The method can receive a plurality of parking assistance functions of the vehicle. The plurality of parking assistance functions can depend on a configuration of the vehicle. For example, the plurality of parking assistance functions can comprise a parking assistance function for parking in a public multi-story car park, a parking assistance function for parking in a public parking lot, a parking assistance function for parking at a private property, and/or a parking assistance function for parking along a street. In addition, a parking assistance function can comprise a function for searching for a parking space. For example, the parking assistance function for parking along the street can comprise searching for a parking space along the street by the vehicle.

The method 100 can receive 104 a current navigation target of the vehicle. The current navigation target can be a current navigation target of a navigation system of the vehicle. Alternatively, the navigation target can be a predicted navigation target of the vehicle which, for example, is predicted using historic route information of the vehicle.

Furthermore, the method 100 can determine 106 a first parking type depending on the current navigation target of the vehicle. If the current navigation target is a multi-story car park or a parking space, the method can derive the first parking type directly from the current navigation target. Additionally or alternatively, the method 100 can determine the first parking type depending on a parking behavior of vehicles of a vehicle fleet in an area around the current navigation target. For example, the parking behavior can comprise a frequency of a parking space along the street and a frequency a of parking space off the street. A parking space along the street and/or a parking space off the street can be depending on a distance of a determined, for example, parking position of a respective vehicle of the vehicle fleet from the street or from a section of the street. If, for example, the distance of a parking position of a vehicle from a street or a section of a street is greater than a predefined distance value, the parking space is off the street. If, for example, the distance of a parking position of a vehicle from a street or a section of a street is smaller than the predefined distance value or equal to a predefined distance value, the parking space is along the street. The predefined distance value can be defined depending on a geographic region and/or a geographic location.

Furthermore, the determination of the first parking type depending on the current navigation target of the vehicle can comprise determining a utilization of the first parking type. To this end, for example, a maximum, available number of parking spaces for the first parking type and a number of parking procedures for the first parking type can be determined. Using the maximum, available number of parking spaces of the first parking type and the number of parking procedures for the first parking type, a utilization for the first parking type can be determined.

Furthermore, the method 100 can provide 108 a recommendation message to the driver of the vehicle for the execution of a parking assistance function from the plurality of parking assistance functions depending on the first parking type. Alternatively, the method 100 can provide the recommendation message to a driver of the vehicle for the execution of a parking assistance function from the plurality of parking assistance functions depending on the first parking type and the utilization of the first parking type. In response to the recommendation message provided, the driver of the vehicle can execute the parking assistance function. The parking assistance function can assist the driver of the vehicle in searching for a parking space and/or park the vehicle in a parking space.

If the current navigation target is a multi-story car park, the recommendation message can comprise a recommendation for the execution of the parking assistance function for parking in a public multi-story car park. If the current navigation target is a public parking lot, the recommendation message can comprise a recommendation for the execution of the parking assistance function for parking in a public parking lot. Furthermore, the method 100 can determine whether the current navigation target is a home address of the driver of the vehicle. If the current navigation target is the home address of the driver of the vehicle, the recommendation message can comprise a recommendation for the execution of a parking assistance function for parking at a private property. The parking assistance function for parking at a private property can, for example, comprise a stored trajectory on the private property, which the vehicle travels fully automatically on the property as far as the endpoint of the stored trajectory. If the parking assistance function for parking at a private property does not contain a stored trajectory, the driver can be recommended to record and store a trajectory to a parking space at the private property using the parking assistance function for parking at the private property. If the driver confirms the recommendation message, the trajectory to the parking space at the private property is recorded and stored. If the navigation target is again the home address of the driver, the parking assistance function for parking at the private property can leave the stored trajectory in order to park the vehicle at the private property.

If the parking behavior in a predefined area around the navigation target indicates that the frequency of a parking space along the street and the frequency of parking space off the street are similarly frequent or equally frequent, the method can suppress the provision of a recommendation message. Alternatively, the method can provide a recommendation message to the driver with multiple parking assistance systems relating to various parking types. Further alternatively, the method can provide the driver of the vehicle with a recommendation message for the execution of a parking assistance function from the plurality of parking assistance functions, the associated parking type of which indicates the lowest utilization.

If the parking behavior in a predefined area around the navigation target indicates that the frequency of a parking space along the street and the frequency of a parking space off the street are considerably different, for example the frequencies differ by more than 10% or more than 20%, the recommendation message can recommend a parking assistance function, the parking type of which is more frequent around the area of the navigation target.

An exemplary sequence of the method 100 can be described from the driver's point of view by way of example as follows: The driver can enter Odeonsplatz in Munich as the navigation target into the navigation system of the vehicle. The method determines the first parking type. To this end, the method can, for example, define an area around the navigation target Odeonsplatz and establish there which parking type is used for parking in the area around the navigation target. The parking type with the highest percentage proportion is determined as the first parking type. In the area around the navigation target, the method can determine parking along the street as the first parking type. The method can provide the driver of the vehicle proactively with a recommendation message with which the parking assistance function for parking along a street is recommended to the driver. The driver can confirm execution of the parking assistance function by means of an entry in response to the recommendation message. The parking assistance function parks the vehicle in a parking space along the street. Preferably, the recommendation message can be recommended to the driver of the vehicle at a predefined distance, for example 500 m or 1 km, from the destination, so that possible parking gaps along the street for parking the vehicle using the parking assistance function can be recognized.

Advantageously, the method can support a user, in particular a driver, of the vehicle efficiently in parking the vehicle at a destination or a navigation target. The user of the vehicle is recommended the parking assistance function with which the user has a high probability of finding a parking space for the vehicle and/or parking in the parking space. The user can thus more simply execute a driving task of parking the vehicle.

### LIST OF DESIGNATIONS

100 Method
102 Receiving a plurality of parking assistance functions
104 Receiving a current navigation target
106 Determining a first parking type
108 Providing a recommendation message

1.-11. (canceled)

12. A method for operating a driver assistance system for supporting a driver of a vehicle in parking the vehicle, the method comprising:
receiving a plurality of parking assistance functions of the vehicle;
receiving a current navigation target of the vehicle;
determining a first parking type depending on the current navigation target of the vehicle; and
providing a recommendation message for the execution of a parking assistance function from the plurality of parking assistance functions to the driver of the vehicle depending on the first parking type.

13. The method as claimed in claim 12, further comprising using a control device to perform determining the first parking type depending on the current navigation target of the vehicle, and providing the recommendation for the execution of the parking assistance function from the plurality of parking assistance function to the driver of the vehicle depending on the first parking type.

14. The method as claimed in claim 12, wherein the parking type is representative of at least one of the group consisting of:
a parking direction; and
a location of a parking space.

15. The method as claimed in claim 14, wherein the plurality of parking assistance functions includes at least one of the group consisting of:
a parking assistance function for parking in a public multi-story car park;
a parking assistance function for parking in a public parking lot;
a parking assistance function for parking at a private property; and
a parking assistance function for parking along a street.

16. The method as claimed in claim 15, further comprising:
receiving an operating input from the driver to execute the parking assistance function in response to the recommendation message provided; and
executing the parking assistance function by the vehicle responsive to receiving the reception of the operating input from the driver to execute the parking assistance function.

17. The method as claimed in claim 12, wherein the plurality of parking assistance functions includes at least one of the group consisting of:
a parking assistance function for parking in a public multi-story car park;
a parking assistance function for parking in a public parking lot;
a parking assistance function for parking at a private property; and
a parking assistance function for parking along a street.

18. The method as claimed in claim 12, wherein the determination of the first parking type depending on the current navigation target of the vehicle comprises determining a utilization of the first parking type; and
wherein the method provides the recommendation message for the execution of a parking assistance function from the plurality of parking assistance functions to a driver of the vehicle depending on the first parking type and the utilization of the first parking type.

19. The method as claimed in claim 12, further comprising:
determining a second parking type depending on the current navigation target of the vehicle;
determining a relative frequency of the determined first parking type and a relative frequency of the determined second parking type; and
providing the recommendation message for the execution of the parking assistance function from the plurality of parking assistance functions based at least in part on at least one of the determined relative frequencies.

20. The method as claimed in claim 19, wherein the method suppresses the provision of the recommendation message for the execution of one of the plurality of parking assistance functions if at least one of the determined relative frequencies lies within a predefined frequency interval.

21. The method as claimed in claim 12, further comprising:
receiving an operating input from the driver to execute the parking assistance function in response to the recommendation message provided; and
executing the parking assistance function by the vehicle responsive to receiving of the operating input from the driver to execute the parking assistance function.

22. The method as claimed in claim 21, wherein the first parking type is determined depending on a parking behavior of vehicles of a vehicle fleet in an area around the current navigation target.

23. The method as claimed in claim 22, wherein the parking behavior comprises a frequency of a parking space along the street and a frequency of a parking space off the street.

24. The method as claimed in claim 23, wherein the parking space along the street and the parking space off the street are determined depending on a distance of a parking position of a respective vehicle of the vehicle fleet.

25. The method as claimed in claim 12, wherein the first parking type is determined depending on a parking behavior of vehicles of a vehicle fleet in an area around the current navigation target.

26. The method as claimed in claim 25, wherein the parking behavior comprises a frequency of a parking space along the street and a frequency of a parking space off the street.

27. The method as claimed in claim 26, wherein the parking space along the street and the parking space off the street are determined depending on a distance of a parking position of a respective vehicle of the vehicle fleet.

28. A non-transitory computer-readable medium for operating a driver assistance system for supporting a driver of a vehicle in parking the vehicle, wherein the computer-readable medium comprises instructions which, when carried out on a computer or control device, carry out the method as claimed in claim 12.

29. A system for operating a driver assistance system for supporting a driver of a vehicle in parking the vehicle, wherein the system is designed to carry out the method as claimed in claim 12.

30. A vehicle comprising the system for operating the driver assistance system for supporting the driver of the vehicle in parking the vehicle as claimed in claim 29.
